(19) United States
(12) Patent Application Publication
(10) Pub. No.: US 2016/0304107 A1
(43) Pub. Date: Oct. 20, 2016

(54) AUTONOMOUS RESET SYSTEM

(71) Applicant: ELECTRO-MOTIVE DIESEL, INC., Lagrange, IL (US)

(72) Inventors: James David SEATON, Westmont, IL (US); Alexander SHUBS, JR., Chicago, IL (US)

(73) Assignee: ELECTRO-MOTIVE DIESEL, INC., Lagrange, IL (US)

(21) Appl. No.: 14/689,191

(22) Filed: Apr. 17, 2015

(51) Int. Cl. B61L 27/00; G05B 19/05

(52) U.S. Cl. CPC B61L 27/0066; G05B 19/056; B61L 27/0077; B61L 27/0083; G05B 2219/1101

(57) ABSTRACT

A control system for a machine may include a component located on-board the machine and having a first state and a second state, wherein the component may be configured to switch from the first state to the second state when an operating parameter of at least one subsystem of the machine deviates from a predetermined range. A control device located on-board the machine may be configured to switch the component between the first state and the second state, and an off-board remote controller interface located remotely from the machine may be configured to receive a maintenance signal from the machine, with the maintenance signal being indicative of the component having switched from the first state to the second state. The off-board remote controller interface may selectively send a command signal to the control device to switch the component from the second state to the first state.

### TECHNICAL FIELD

The present disclosure relates generally to a reset system and, more particularly, to an autonomous reset system that can be used with components such as circuit breakers.

### BACKGROUND

Rail vehicles may include multiple powered units, such as locomotives, that are mechanically coupled or linked together in a consist. The consist of powered units operates to provide tractive and/or braking efforts to propel and stop movement of the rail vehicle. The powered units in the consist may change the supplied tractive and/or braking efforts based on a data message that is communicated to the powered units. For example, the supplied tractive and/or braking efforts may be based on Positive Train Control (PTC) instructions or control information for an upcoming trip. The control information may be used by a software application to determine the speed of the rail vehicle for various segments of an upcoming trip of the rail vehicle.

A goal in the operation of the locomotives in a train is to eliminate the need for an operator on-board the train. In order to achieve the goal of providing automatic train operation (ATO), a reliable communication system must be provided in order to transmit train control commands and other data indicative of operational characteristics associated with various subsystems of the locomotive consists between the train and an off-board, remote controller interface (also sometimes referred to as the “back office”). The communication system must be capable of transmitting data messages having the information used to control the tractive and/or braking efforts of the rail vehicle and the operational characteristics of the various consist subsystems while the rail vehicle is moving. The communication system must also be able to transmit information regarding a detected fault on-board a locomotive, and respond with control commands to reset the fault.

One example of a train that includes a communication system that allows the transfer of control commands from a lead locomotive to a remote locomotive is disclosed in U.S. Pat. No. 8,364,338 of Peltonen et al. that issued on Jan. 29, 2013 (“the '338 patent”). In particular, the '338 patent discloses a system and method for remotely administering a fault detected on an unmanned powered system that is controlled through a lead powered system. The method includes detecting an operational fault on an unmanned powered system, communicating information about the fault to the lead powered system through a wireless communication protocol, and communicating a reset message to the unmanned powered system.

Although useful in allowing for control of an unmanned remote trailing locomotive in a train by wireless signals sent from a lead locomotive of the train, the system of the '338 patent may be limited. In particular, the '338 patent does not provide a way for a remote operator at a back office or other remote controller interface, or a third party located remotely and with access only to an Internet-connected terminal, to receive information on the status of a locomotive and send commands to the locomotive from the remote controller interface or remote, Internet-connected terminal.

The present disclosure is directed at overcoming one or more of the shortcomings set forth above and/or other problems of the prior art.

### SUMMARY

In one aspect, the present disclosure is directed to a control system for a machine. The control system may include a component located on-board the machine and having a first state and a second state. The component may be configured to switch from the first state to the second state when an operating parameter of at least one subsystem of the machine deviates from a predetermined range. A control device located on-board the machine may be configured to switch the component between the first state and the second state, and an off-board remote controller interface located remotely from the machine may be configured to receive a maintenance signal from the machine, the maintenance signal being indicative of the component having switched from the first state to the second state, and selectively send a command signal to the control device to switch the component from the second state to the first state.

In another aspect, the present disclosure is directed to a control system for a locomotive. The control system may include an engine located on-board the locomotive, a component located on-board the locomotive and having a first state and a second state, and the component being configured to switch from the first state to the second state when an operating parameter of at least one subsystem of the locomotive deviates from a predetermined range. A control device located on-board the locomotive may be configured to switch the component between the first state and the second state, and an off-board controller located remotely from the locomotive may be configured to receive a maintenance signal from the locomotive. The maintenance signal may be indicative of the component having switched from the first state to the second state, and the off-board controller may send a command signal to the control device to selectively switch the component from the second state to the first state based on the maintenance signal.

In yet another aspect, the present disclosure is directed to a method of controlling a machine. The method may include switching a component located on-board the machine from a first state to a second state in response to an operating parameter of at least one subsystem of the machine deviating from a predetermined range. The method may further include transmitting a maintenance signal from the machine to a remote controller interface off-board the machine, the maintenance signal being indicative of the component having switched from the first state to the second state. The method may still further include receiving a command signal from the remote controller interface at a control device on-board the machine, the command signal causing the control device to autonomously switch the component from the second state to the first state.

### BRIEF DESCRIPTION OF THE DRAWING

FIG. 1 is a schematic diagram of one implementation of a communication system for a train;

FIG. 2 is a block diagram of one implementation of a communication system that allows a third party interface with a control system of a train.

### DETAILED DESCRIPTION

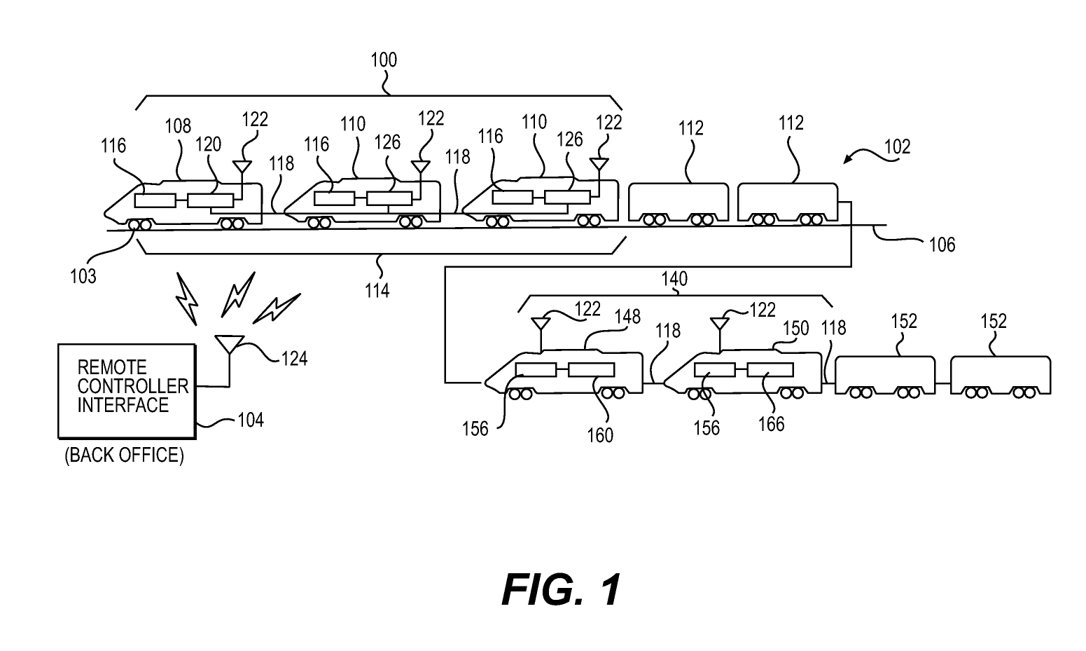

FIG. 1 is a schematic diagram of one embodiment of a control system 100 for a train 102 traveling along a track 106. The train may include multiple rail cars (including powered and/or non-powered rail cars or units) linked together as one or more consists or a single rail car (a powered or non-powered rail car or unit). The control system 100 may provide for cost savings, improved safety, increased reliability, flexibility, and convenience in the control of the train 102 through communication of network data between an off-board remote controller interface 104 and the train 102. The control system 100 may also provide a means for remote operators or third party operators to communicate with the various locomotives or other powered cars of the train 102 from remote interfaces that may include any computing device connected to the Internet or other wide area or local communications network. The control system 100 may be used to convey a variety of network data and commands in the form of messages communicated to the train 102, such as packetized data or information that is communicated in data packets, from the off-board remote controller interface 104. The off-board interface 104 may also be configured to receive remote alerts and other data from a controller on-board the train, and forward those alerts and data to desired parties via pagers, mobile telephone, email, and online screen alerts. The data communicated between the train 102 and the off-board remote controller interface 104 may include signals indicative of various operational parameters associated with components and subsystems of the train, and command and control signals operative to change the state of various circuit breakers, actuators, switches, handles, relays, and other electronically-controllable devices on-board any locomotive or other powered unit of the train 102. The off-board remote controller interface 104 may be connected with an antenna module 124 configured as a wireless transmitter or transceiver to wirelessly transmit data messages to the train 102. The messages may originate elsewhere, such as in a rail-yard back office system, a remotely located server, a third party server, a computer disposed in a rail yard tower, and the like, and be communicated to the off-board interface 104 by wired and/or wireless connections. Alternatively, the off-board interface 104 may be a satellite that transmits the message down to the train 102 or a cellular tower disposed remote from the train 102 and the track 106. Other devices may be used as the off-board interface 104 to wirelessly transmit the messages. For example, other wayside equipment, base stations, or back office servers may be used as the off-board interface 104. By way of example only, the off-board interface 104 may use one or more of the Transmission Control Protocol (TCP), Internet Protocol (IP), TCP/IP, User Datagram Protocol (UDP), or Internet Control Message Protocol (ICMP) to communicate network data over the Internet with the train 102. As described below, the network data can include information used to automatically and/or remotely control operations of the train 102 or subsystems of the train, and/or reference information stored and used by the train 102 during operation of the train 102. The network data communicated to the off-board interface 104 from the train 102 may also provide alerts and other operational information that allows for remote monitoring, diagnostics, asset management, and tracking of the state of health of all of the primary power systems and auxiliary subsystems such as HVAC, air brakes, lights, event recorders, and the like.

The train 102 may include a lead consist 114 of powered locomotives, including the interconnected powered units 108 and 110, one or more trailing consists 140 of powered locomotives, including powered units 148, 150, and additional non-powered units 112, 152. “Powered units” refers to rail cars that are capable of self-propulsion, such as locomotives. “Non-powered units” refers to rail cars that are incapable of self-propulsion, but which may otherwise receive electric power for other services. For example, freight cars, passenger cars, and other types of rail cars that do not propel themselves may be “non-powered units”, even though the cars may receive electric power for cooling, heating, communications, lighting, and other auxiliary functions.

In the illustrated embodiment of FIG. 1, the powered units 108, 110 represent locomotives joined with each other in the lead consist 114. The lead consist 114 represents a group of two or more locomotives in the train 102 that are mechanically coupled or linked together to travel along a route. The lead consist 114 may be a subset of the train 102 such that the lead consist 114 is included in the train 102 along with additional trailing consists of locomotives, such as trailing consist 140, and additional non-powered units 152, such as freight cars or passenger cars. While the train 102 in FIG. 1 is shown with a lead consist 114, and a trailing consist 140, alternatively the train 102 may include other numbers of locomotive consists joined together or interconnected by one or more intermediate powered or non-powered units that do not form part of the lead and trailing locomotive consists.

The powered units 108, 110 of the lead consist 114 include a lead powered unit 108, such as a lead locomotive, and one or more trailing powered units 110, such as trailing locomotives. As used herein, the terms “lead” and “trailing” are designations of different powered units, and do not necessarily reflect positioning of the powered units 108, 110 in the train 102 or the lead consist 114. For example, a lead powered unit may be disposed between two trailing powered units. Alternatively, the term “lead” may refer to the first powered unit in the train 102 or the lead consist 114, and “trailing” powered units may refer to powered units positioned after the lead powered unit. In another embodiment, the term “lead” refers to a powered unit that is designated for primary control of the lead consist 114 and “trailing” refers to powered units that are under at least partial control of the lead powered unit.

The powered units 108, 110 include a connection at each end of the powered unit 108, 110 to couple propulsion subsystems 116 of the powered units 108, 110 such that the powered units 108, 110 in the lead consist 114 function together as a single tractive unit. The propulsion subsystems 116 include electric and/or mechanical devices and components, such as diesel engines, electric generators, and traction motors, used to provide tractive effort that propels the powered units 108, 110 and braking effort that slows the powered units 108, 110.

Similar to lead consist 114, the embodiment shown in FIG. 1 also includes a trailing consist 140, including a lead powered unit 148 and a trailing powered unit 150. The trailing consist 140 may be located at a rear end of the train 102, or at some intermediate point along the train 102. Non-powered units 112 may separate the lead consist 114 from the trailing consist 140, and additional non-powered units 152 may be pulled behind the trailing consist 140.

The propulsion subsystems 116 of the powered units 108, 110 in the lead consist 114 may be connected and communicatively coupled with each other by a network connection 118. In one embodiment, the network connection 118 includes a net port and jumper cable that extends along the train 102 and between the powered units 108, 110. The network connection 118 may be a cable that includes twenty seven pins on each end that is referred to as a multiple unit cable, or MU cable. Alternatively, a different wire, cable, or bus, or other communication medium, may be used as the network connection 118. For example, the network connection 118 may represent an Electrically Controlled Pneumatic brake line (ECPB), a fiber optic cable, or wireless connection. Similarly, the propulsion subsystems 156 of the powered units 148, 150 in the trailing consist 140 may be connected and communicatively coupled to each other by the network connection 118, such as a MU cable extending between the powered units 148, 150.

The network connection 118 may include several channels over which network data is communicated. Each channel may represent a different pathway for the network data to be communicated. For example, different channels may be associated with different wires or busses of a multi-wire or multi-bus cable. Alternatively, the different channels may represent different frequencies or ranges of frequencies over which the network data is transmitted.

The powered units 108, 110 may include communication units 120, 126 that are used to control operations of various components and subsystems, such as the propulsion subsystems 116 of the powered units 108, 110. The communication unit 120 disposed in the lead powered unit 108 may be referred to as a lead communication unit. As described below, the lead communication unit 120 may be the unit that initiates the transmission of data packets forming a message to the off-board, remote controller interface 104. For example, the lead communication unit 120 may transmit a message to the off-board interface 104 containing information on an operational state of the lead powered unit 108, such as a throttle setting, a brake setting, readiness for dynamic braking, the tripping of a circuit breaker on-board the lead powered unit, or other operational characteristics. The communication units 126 may be disposed in different trailing powered units 110 and may be referred to as trailing communication units. Alternatively, one or more of the communication units 120, 126 may be disposed outside of the corresponding powered units 108, 110, such as in a nearby or adjacent non-powered unit 112. Another lead communication unit 160 may be disposed in the lead powered unit 148 of the trailing consist 140. The lead communication unit 160 of the trailing consist 140 may be a unit that receives data packets forming a message transmitted by the off-board, remote controller interface 104. For example, the lead communication unit 160 of the trailing consist 140 may receive a message from the off-board interface 104 providing operational commands that are based upon the information transmitted to the off-board interface 104 from the lead powered unit 108 of the lead consist 114. A trailing communication unit 166 may be disposed in a trailing powered unit 150 of the trailing consist 140, and interconnected with the lead communication unit 160 via the network connection 118.

The communication units 120, 126 in the lead consist 114, and the communication units 160, 166 in the trailing consist 140 may be connected with the network connection 118 such that all of the communication units for each consist are communicatively coupled with each other by the network connection 118 and linked together in a computer network. Alternatively, the communication units may be linked by another wire, cable, or bus, or be linked by one or more wireless connections.

The networked communication units 120, 126, 160, 166 may include antenna modules 122. The antenna modules 122 may represent separate individual antenna modules or sets of antenna modules disposed at different locations along the train 102. For example, an antenna module 122 may represent a single wireless receiving device, such as a single 220 MHz TDMA antenna module, a single cellular modem, a single wireless local area network (WLAN) antenna module (such as a “Wi-Fi” antenna module capable of communicating using one or more of the IEEE 802.11 standards or another standard), a single WiMax (Worldwide Interoperability for Microwave Access) antenna module, a single satellite antenna module (or a device capable of wirelessly receiving a data message from an orbiting satellite), a single 3G antenna module, a single 4G antenna module, and the like. As another example, an antenna module 122 may represent a set or array of antenna modules, such as multiple antenna modules having one or more TDMA antenna modules, cellular modems, Wi-Fi antenna modules, WiMax antenna modules, satellite antenna modules, 3G antenna modules, and/or 4G antenna modules.

As shown in FIG. 1, the antenna modules 122 may be disposed at spaced apart locations along the length of the train 102. For example, the single or sets of antenna modules represented by each antenna module 122 may be separated from each other along the length of the train 102 such that each single antenna module or antenna module set is disposed on a different powered or non-powered unit 108, 110, 112, 148, 150, 152 of the train 102. The antenna modules 122 may be configured to send data to and receive data from the off-board remote controller interface 104. For example, the off-board interface 104 may include an antenna module 124 that wirelessly communicates the network data from a remote location that is off of the track 106 to the train 102 via one or more of the antenna modules 122. Alternatively, the antenna modules 122 may be connectors or other components that engage a pathway over which network data is communicated, such as through an Ethernet connection.

The diverse antenna modules 122 enable the train 102 to receive the network data transmitted by the off-board interface 104 at multiple locations along the train 102. Increasing the number of locations where the network data can be received by the train 102 may increase the probability that all, or a substantial portion, of a message conveyed by the network data is received by the train 102. For example, if some antenna modules 122 are temporarily blocked or otherwise unable to receive the network data as the train 102 is moving relative to the off-board interface 104, other antenna modules 122 that are not blocked and are able to receive the network data may receive the network data. An antenna module 122 receiving data from the off-board device 104 may in turn re-transmit that received data to the appropriate lead communication unit 120 of lead locomotive consist 114, or lead communication unit 160 of trailing locomotive consist 140. Any data packet of information received from the off-board interface 104 may include header information or other means of identifying which locomotive in which locomotive consist the information is intended for.

Each locomotive or powered unit of the train 102 may include a car body supported at opposing ends by a plurality of trucks. Each truck may be configured to engage the track 106 via a plurality of wheels, and to support a frame of the car body. One or more traction motors may be associated with one or all wheels of a particular truck, and any number of engines and generators may be mounted to the frame within the car body to make up the propulsion subsystems 116, 156 on each of the powered units. The propulsion subsystems of each of the powered units may be further interconnected throughout the train 102 along one or more high voltage power cables in a power sharing arrangement. The DC or AC power provided from the propulsion subsystems 116, 156 along a power cable may drive AC or DC traction motors to propel the wheels. Each of the traction motors may also be operated in a dynamic braking mode as a generator of electric power that may be provided back to the power cables and/or energy storage devices. Control over engine operation (e.g., starting, stopping, fueling, exhaust aftertreatment, etc.) and traction motor operation, as well as other locomotive controls, may be provided by way of various controls housed within a cab supported by the frame of the train 102. In some implementations of this disclosure, initiation of these controls may be implemented in the cab of the lead powered unit in the lead consist of the train. The controls may include an automated energy management system configured to determine one or more of throttle requests, dynamic braking requests, and pneumatic braking requests for one or more of the powered and non-powered units of the train. The automated energy management system may be configured to make these various requests based on a variety of measured operational parameters, track conditions, freight loads, trip plans, and predetermined maps or other stored data with a goal of improving availability, safety, timeliness, overall fuel economy and emissions output for the entire train. The cab of the lead powered unit may also house a plurality of input devices and control system interfaces. The input devices may be used by an operator to manually control the locomotive, or controlled electronically via messages received from off-board the train. Input devices may include, among other things, an engine run/isolation switch, a generator field switch, an automatic brake handle, an independent brake handle, a lockout device, and any number of circuit breakers. Manual input devices may include switches, levers, pedals, wheels, knobs, push-pull devices, touch screen displays, etc.

Operation of the engines, generators, and other auxiliary devices may be at least partially controlled by switches or other input devices that may be manually movable between a run or activated state and an isolation or deactivated state by an operator of the train 102. The input devices may be additionally or alternatively activated and deactivated by solenoid actuators or other electrical, electromechanical, or hydraulic devices. As one example, a toggling device associated with an engine (not shown) may be manually and/or autonomously moved to a run state, in which the engine may be allowed to start in response to a command generated from on-board the train 102, or in response to a command received from the off-board interface 104. The toggling device may also be moved to an isolation state, in which the engine may be shutdown (i.e., turned off) and not allowed to restart. In one embodiment, moving the toggling device to the run state causes startup of the engine and, likewise, moving the toggling device to the isolation state causes the engine to shut down. In another embodiment, moving the toggling device to the run state simply allows subsequent startup of the engine using other input devices, and the toggling device is only moved to the isolation state after engine shutdown to inhibit restart of the engine. In either scenario, the engine may not be restarted from on-board the train while the toggling device is in the isolation state. The operator of the locomotive may manually move the toggling device to the run state at the start of a work shift or trip, and move the toggling device to the isolation position at the end of the work shift or trip. Off-board interface 104 may also require compliance with security protocols to ensure that only designated personnel may remotely activate or deactivate components on-board the train from the off-board interface 104 after certain prerequisite conditions have been met.

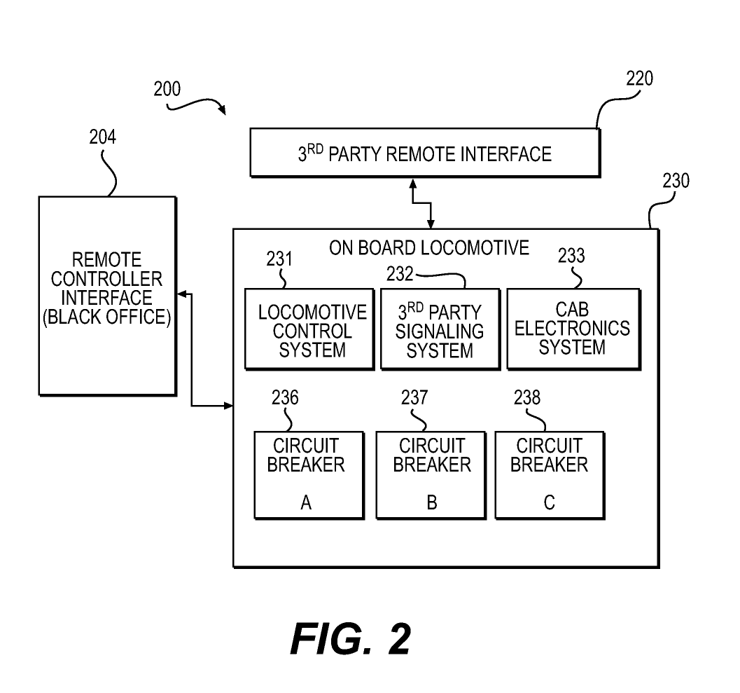

Referring to FIG. 2, circuit breakers 236, 237, 238 may each be associated with a particular component or subsystem of a locomotive on the train 102, and configured to trip when operating parameters associated with the component or subsystem deviate from expected or predetermined ranges. For example, the circuit breaker 236 may be associated with power directed to individual traction motors, the circuit breaker 237 may be associated with power directed to an HVAC component, and circuit breaker 238 may be associated with power directed to lighting or other electrical components or subsystems. In this example, when a power draw greater than an expected draw occurs, the circuit breaker 236, 237, 238 may trip, or switch from a first state to a second state, to interrupt the corresponding circuit. In some implementations of this disclosure, one of the circuit breakers 236, 237, 238 may be associated with an on-board control system that controls wireless communication with an off-board remote controller interface 204. After a particular circuit breaker 236, 237, 238 trips, the associated component or subsystem may be disconnected from the main electrical circuit of the locomotive 230 and remain nonfunctional until the corresponding breaker is reset. The circuit breakers may be manually tripped or reset and, in the embodiment shown in FIG. 2, include actuators or other control devices that can be selectively energized to autonomously or remotely switch the state of the associated circuit breakers in response to a corresponding command received from the off-board remote controller interface 204. In some embodiments, a maintenance signal may be transmitted to the off-board interface 204 upon switching of a circuit breaker from a first state to a second state, thereby indicating that action such as a reset of the circuit breaker is needed.

As further shown in FIG. 2, an exemplary embodiment of a control system 200 according to this disclosure may include an on-board controller of a locomotive 230 comprising a microprocessor-based locomotive control system 231 having at least one programmable logic controller (PLC), a third party signaling system 232, and an integrated cab electronics system 233, all mounted within a cab of the locomotive. The integrated cab electronics system 233 may comprise at least one integrated display computer configured to receive and display data from the outputs of one or more of machine gauges, indicators, sensors, and controls, process and integrate the received data, receive command signals from the off-board remote controller interface 204, and supply commands based on the data and command signals to the microprocessor-based locomotive control system 231.

The microprocessor-based locomotive control system 231 may be communicatively coupled with the traction motors, engines, braking subsystems, input devices, actuators, circuit breakers, and other devices used to control operation of various components and subsystems on the locomotive. In various alternative implementations of this disclosure, some operating commands, such as throttle and dynamic braking commands, may be communicated from the integrated cab electronics system 233 to the locomotive control system 231, and other operating commands, such as braking commands, may be communicated from the integrated cab electronics system 233 to a separate electronically controlled pneumatic brake system (not shown). Examples of the types of controls that may be performed by the locomotive control system 231 may include radar-based wheel slip control for improved adhesion, automatic engine start stop (AESS) for improved fuel economy, control of the lengths of time at which traction motors are operated at temperatures above a predetermined threshold, the amount of exhaust gas recirculation (EGR) and other exhaust aftertreatment processes performed based on detected levels of certain pollutants, and other controls performed to improve safety, increase overall fuel economy, reduce overall emission levels, and increase longevity and availability of the locomotives. The PLC of the microprocessor-based locomotive control system 231 may also be configurable to selectively set parameters outside of which the circuit breakers will trip or move from a first state to a second state. In alternative implementations, the PLC may be further configurable to set additional predetermined ranges for operating parameters associated with components or subsystems. A maintenance signal may be communicated to the off-board interface 204 when a component has switched from a first state to a second state, indicating that a measured operating parameter deviates from the predetermined range. The PLC of the microprocessor-based locomotive control system 231 may also be configurable to receive one or more signals indicative of at least one of a throttle command, dynamic braking readiness, and a brake command, and output one or more corresponding command signals configured to change at least one of a throttle position for the machine, activation of dynamic braking, and application of a brake, respectively.

The integrated cab electronics system 233 may provide integrated computer processing and display capabilities on-board the train 102, and may be communicatively coupled with a plurality of cab gauges, indicators, and sensors, as well as being configured to receive commands from the remote controller interface 204 and from the third party signaling system 232. The cab electronics system may be configured to process outputs from one or more of the gauges, indicators, and sensors, and supply commands to the locomotive control system 231. The third party signaling system 232 may provide the capability on-board the locomotive 230 to receive and process commands and other data transmitted by a third party remote interface 220. The third party remote interface 220 may comprise a remote terminal accessible to designated parties other than an owner or lessor of the off-board remote controller interface 204 for the purpose of remotely monitoring and controlling locomotives of the train. In various implementations, the third party remote interface 220 may comprise a laptop, hand-held device, or other computing device or server with the proper software, encryption capabilities, and Internet access for communicating with the on-board controller of the locomotive 230. Control commands from the third party remote interface 220 may be received by the third party signaling system 232 on-board the locomotive, which in turn may process the commands and provide the processed commands to the cab electronics system 233. In one exemplary implementation, a command signal may be transmitted from the third party remote interface 220 to reset a tripped circuit breaker associated with an on-board control system that controls wireless communication with the off-board remote controller interface 204.

The control systems and interfaces on-board and off-board the train may embody single or multiple microprocessors, field programmable gate arrays (FPGAs), digital signal processors (DSPs), programmable logic controllers (PLCs), etc., that include a means for controlling operations of the train 102 in response to operator requests, built-in constraints, sensed operational parameters, and/or communicated instructions from the remote controller interface 204 and/or the third party remote interface 220. Numerous commercially available microprocessors can be configured to perform the functions of these components. Various known circuits may be associated with these components, including power supply circuitry, signal-conditioning circuitry, actuator driver circuitry (i.e., circuitry powering solenoids, motors, or piezo actuators), and communication circuitry.

The locomotive 230 may be outfitted with any number and type of sensors known in the art for generating signals indicative of associated operating parameters. In one example, the locomotive 230 may include a temperature sensor configured to generate a signal indicative of a coolant temperature of an engine on-board the locomotive. Additionally or alternatively, sensors may include brake temperature sensors, exhaust sensors, fuel level sensors, pressure sensors, knock sensors, reductant level or temperature sensors, speed sensors, or any other sensor known in the art. The signals generated by the sensors may be directed to the integrated cab electronics system 233 for further processing and generation of appropriate commands.

Any number and type of warning devices may also be located on-board the locomotive 230, including an audible warning device and/or a visual warning device. Warning devices may be used to alert an operator of the locomotive 230 of an impending operation, for example startup of the engine(s). Warning devices may be triggered manually from on-board the locomotive (e.g., in response to movement of a component to the run state) and/or remotely from off-board the locomotive (e.g., in response to commands from the remote controller interface 204 or the third party remote interface 220.) When triggered from off-board the locomotive, a corresponding command signal used to initiate operation of the warning device may be communicated to the on-board controller and the cab electronics system 233.

The off-board remote controller interface 204 may include any means for monitoring, recording, storing, indexing, processing, and/or communicating various operational aspects of the locomotive 230. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from different types of computer program products or non-transitory computer-readable media such as computer chips and secondary storage devices, including hard disks, floppy disks, optical media, CD-ROM, or other forms of RAM or ROM.

The off-board remote controller interface 204 may be configured to execute instructions stored on computer readable media to perform methods of remote control of the locomotive 230. That is, as will be described in more detail in the following section, on-board control (manual and/or autonomous control) of some operations of the locomotive (e.g., operations of traction motors, engine(s), circuit breakers, etc.) may be selectively overridden by the off-board remote controller interface 204.

Remote control of the various powered and non-powered units on the train 102 through communication between the on-board cab electronics system 233 and the off-board remote controller interface 204 and third party remote interface 220 may be facilitated via the various communication units 120, 126, 160, 166 spaced along the train 102. The communication units may include hardware and/or software that enables sending and receiving of data messages between the powered units of the train and the off-board interfaces. The data messages may be sent and received via a direct data link and/or a wireless communication link, as desired. The direct data link may include an Ethernet connection, a connected area network (CAN), or another data link known in the art. The wireless communications may include satellite, cellular, infrared, and any other type of wireless communications that enable the communication units to exchange information between the off-board interfaces and the various components and subsystems of the train 102.

In various exemplary implementations of this disclosure, the lead powered unit 108 of the lead consist 114 may include an on-board control system. The on-board control system may include an energy management system and/or operator inputs configured to provide throttle requests, dynamic braking requests, and pneumatic braking requests to help regulate movements and/or operations of the various subsystems of the associated locomotive (e.g., direct operations of associated traction motors, engines, circuit breakers, etc.). The on-board control system of the lead powered unit 108 may include the integrated cab electronics system 233 configured to receive the requests from the operator or energy management system as well as commands from the off-board remote controller interface 204 and the third party remote interface 220. In some implementations, the integrated cab electronics system may receive the requests after they have been processed by a locomotive interface gateway, which may also enable communication of the requests through a cellular modem to an off-board system. The integrated cab electronics system may be configured to communicate commands (e.g., throttle, dynamic braking, and electronically controlled pneumatic braking commands) to the locomotive control system 231 and an electronically controlled pneumatic brake system on-board the lead powered unit 108 in order to autonomously control the movements and/or operations of the lead powered unit.

In parallel with or subsequent to communicating commands to the locomotive control system 231 of the lead powered unit 108, the integrated cab electronics system 233 on-board the lead powered unit 108 of the lead consist 114 may also communicate commands to the off-board remote controller interface 204. The commands may be communicated either directly or through a locomotive interface gateway, via a wireless, wifi or cellular modem, off-board the lead powered unit 108 of the lead consist 114 to the off-board remote controller interface 204. The remote controller interface 204 may then communicate the commands received from the lead powered unit 108 to the lead powered unit 148 of the trailing consist 140. The commands may be received at the lead powered unit 148 of the trailing consist 140 via a wireless or cellular modem, and communicated either directly or through a locomotive interface gateway to a cab electronics system. The cab electronics system on-board the lead powered unit 148 of the trailing consist 140 may be configured to communicate the commands received from the lead powered unit 108 to a locomotive control system and electronic air brake system on-board the lead powered unit 148. The commands from the lead powered unit 108 of the lead consist 114 may also be communicated via the network connection 118 from the lead powered unit 148 of the trailing consist 140 to the trailing powered unit 150 of the trailing consist 140. The result of configuring all of the lead powered units of the lead and trailing consists to communicate via the off-board remote controller interface 204 is that the lead powered unit of each trailing consist may respond quickly and in close coordination with commands responded to by the lead powered unit of the lead consist. Additionally, each of the powered units in various consists along a long train may reliably and nearly instantaneously receive commands such as throttle, dynamic braking, and pneumatic braking commands initiated by a lead locomotive in a lead consist regardless of location and conditions.

The integrated cab electronics systems on the powered units 108, 110 of the lead consist 114 and on the powered units 148, 150 of the trailing consist 140 may also be configured to receive and generate commands for configuring various switches and handles on-board each of the powered units of the train as required before the train begins on a journey, or after a failure occurs that requires reconfiguring of all or some of the powered units. Examples of switches and handles that may require configuring or reconfiguring before a journey or after a failure may include an engine run switch, a generator field switch, an automatic brake handle, and an independent brake handle. Remotely controlled actuators on-board the powered units in association with each of the switches and handles enable remote, autonomous configuring of each of the devices. For example, before the train begins a journey, or after a critical failure has occurred on one of the lead or trailing powered units, commands may be sent from the off-board remote controller interface 204 or the third party remote interface 220 to any powered unit 108, 110, 148, 150 in order to automatically reconfigure all of the switches and handles as required on-board each powered unit without requiring an operator to be on-board the train. This capability saves the time and expense of having to delay the train while sending an operator to each of the powered units on the train to physically switch and reconfigure all of the devices required.

An exemplary method of controlling one or more powered units in a train in accordance with various aspects of this disclosure is described in more detail in the following section.

### INDUSTRIAL APPLICABILITY

The control system of the present disclosure may be applicable to any locomotive or other powered machine where remote access to particular functions of the locomotive may be desirable. These functions may normally be controlled manually from on-board the locomotive or other machine, and remote access to these functions may provide a way to enable automatic train operation (ATO) when human operators are not present or available at the locomotive. An exemplary implementation of one mode of operation of the control system 200 shown in the embodiment of FIG. 2 will now be described in detail.

During normal operation, a human operator may be located on-board the locomotive 230 and within the cab of the locomotive. The human operator may be able to control when an engine or other subsystem of the train is started or shut down, which traction motors are used to propel the locomotive, and when and what circuit breakers should be reset or tripped. The human operator may also be required to monitor multiple gauges, indicators, sensors, and alerts while making determinations on what controls should be initiated. However, there may be times when the operator is not available to perform these functions, when the operator is not on-board the locomotive 230, and/or when the operator is not sufficiently trained or alert to perform these functions. In addition, the control system 200 in accordance with this disclosure facilitates access to and availability of the locomotives in a train for authorized third parties, including providing redundancy and reliability of monitoring and control of the locomotives and subsystems on-board the locomotives.

For example, a method of controlling a particular locomotive in accordance with various aspects of this disclosure may include switching a component such as a circuit breaker 236, 237, 238 on-board the locomotive 230 from a first state, in which the circuit breaker has not tripped, to a second state, in which the circuit breaker has tripped. The circuit breaker may be tripped in response to an operating parameter of at least one component or subsystem of the locomotive deviating from a predetermined range. When such a deviation occurs, a maintenance signal may be transmitted from the locomotive to an off-board remote controller interface 204. The maintenance signal may be indicative of the component or subsystem having deviated from the predetermined range as indicated by another component such as a circuit breaker having switched from a first state to a second state. The method may further include receiving a command signal from the remote controller interface 204 at a control device on-board the locomotive 230, with the command signal causing the control device to autonomously switch the component from the second state back to the first state. In the case of a tripped circuit breaker, the command may result in resetting the circuit breaker.

The method of controlling the locomotive may also include configuring a programmable logic controller (PLC) of a microprocessor-based locomotive control system 231 on-board the locomotive 230 to selectively set the predetermined range for the operating parameter of the component. In the case of a circuit breaker, the predetermined range may be a range of currents flowing within a circuit as detected by a current sensor or the circuit breaker itself, within which the circuit is considered to be in good working order. The method of controlling the locomotive may still further include an integrated cab electronics system 233 on-board the locomotive 230 receiving and processing data outputs from one or more of gauges, indicators, sensors, and controls on-board the locomotive. The cab electronics system 233 may also receive and process, e.g., throttle, dynamic braking, and pneumatic braking requests from an energy management system and/or human operator, and command signals from the remote controller interface 204. The cab electronics system 233 may then supply appropriate commands to the PLC based on the requests, data outputs and command signals. The microprocessor-based locomotive control system 231 may then reset the circuit breaker 236, 237, 238 in accordance with the commands received from the cab electronics system 233, and after confirming that certain prerequisite conditions have been met.

Methods of controlling a machine in accordance with various aspects of this disclosure may include switching a component between a first state and a second state when a particular operating parameter of another component or subsystem of the machine has deviated from a predetermined range. These changes in state may occur when an operating parameter crosses a particular threshold. In various exemplary implementations, a switch from a first state to a second state may occur as a result of a change in a quantity or flow rate of a fuel, a change in a quantity or flow rate of a coolant, a change in a quantity or flow rate of a reductant used in exhaust aftertreatment, a change in an electrical characteristic of a circuit, a change in a temperature, a change in a pressure, a change in a rotational speed of a component, and a change in a physical location of the machine.

In addition to or instead of transmitting a maintenance signal from the locomotive to an off-board remote controller interface 204 when a component or subsystem switches from a first state to a second state, the maintenance signal may be transmitted to a third party remote interface 220. The third party remote interface 220 may then send a command signal to a control device on-board the locomotive to switch the component or subsystem from the second state back to the first state. The command signal from the third party remote interface 220 may be received by a third party signaling system 232 on-board the locomotive, and the command signal may be modulated as required for compatibility with the cab electronics system 233 and the PLC of the locomotive control system 231. Just as when a command signal is received from a remote controller interface 204, the command signal from the third party remote interface 220 may be sent from the cab electronics system 233 to the locomotive control system 231 to cause the component or subsystem to switch from the second state back to the first state. In one exemplary implementation, a command signal may be transmitted from the third party remote interface 220 to reset a tripped circuit breaker associated with an on-board control system that controls wireless communication with the off-board remote controller interface 204. This feature may provide a backup alternative when wireless communication from the off-board remote controller interface 204 to the locomotive 230 fails or becomes temporarily unavailable.

It will be apparent to those skilled in the art that various modifications and variations can be made to the control system and method of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A control system for a machine, comprising:
a component located on-board the machine and having a first state and a second state, the component being configured to switch from the first state to the second state when an operating parameter of at least one subsystem of the machine deviates from a predetermined range;
a control device located on-board the machine and being configured to switch the component between the first state and the second state; and
an off-board remote controller interface located remotely from the machine and being configured to:
receive a maintenance signal from the machine, the maintenance signal being indicative of the component having switched from the first state to the second state; and
selectively send a command signal to the control device to switch the component from the second state to the first state.

2. The control system of claim 1, further including an on-board controller connected with the component, the on-board controller comprising:
a microprocessor-based machine control system, wherein the microprocessor-based machine control system comprises a programmable logic controller (PLC) configurable to selectively set the predetermined range for the operating parameter; and
an integrated cab electronics system comprising at least one integrated display computer configured to:
receive and display data from the outputs of one or more of machine gauges, indicators, sensors, and controls;
process and integrate the received data;
receive the command signal from the off-board remote controller interface; and
supply commands based on the data and command signal to the microprocessor-based machine control system; and
the on-board controller being in wireless communication with the off-board remote controller interface.

3. The control system of claim 1, wherein a switch between the first and second states comprises one or more of a switch to an activated or enabled state, a switch to a deactivated or disabled state, a change in a quantity or flow rate of a fuel, a change in a quantity or flow rate of a coolant, a change in a quantity or flow rate of a reductant used in exhaust aftertreatment, a change in an electrical characteristic, a change in a temperature, a change in a pressure, a change in a rotational speed of the component, and a change in a physical location of the machine.

4. The control system of claim 1, wherein the component is a traction motor.

5. The control system of claim 1, wherein the component is a circuit breaker.

6. The control system of claim 1, wherein the component is a combination of at least one generator and at least one engine.

7. The control system of claim 2, further including:
a third party remote interface configured to:
receive a maintenance signal from the machine, the maintenance signal being indicative of the component having switched from the first state to the second state; and
selectively send a command signal to the control device to switch the component from the second state to the first state based on the maintenance signal.

8. The control system of claim 7, wherein the on-board controller further includes a third party signaling system configured to communicate with the third party remote interface and modulate command signals received from the third party remote interface for compatibility with the microprocessor-based machine control system.

9. The control system of claim 2, wherein the PLC is configurable to receive one or more signals indicative of at least one of a throttle command, dynamic braking readiness, and a brake command, and output one or more corresponding command signals configured to change at least one of a throttle position for the machine, activation of dynamic braking, and application of a brake, respectively.

10. A control system for a locomotive, comprising:
an engine located on-board the locomotive;
a component located on-board the locomotive and having a first state and a second state, the component being configured to switch from the first state to the second state when an operating parameter of at least one subsystem of the locomotive deviates from a predetermined range;
a control device located on-board the locomotive and being configured to switch the component between the first state and the second state; and
an off-board controller located remotely from the locomotive and being configured to:
receive a maintenance signal from the locomotive, the maintenance signal being indicative of the component having switched from the first state to the second state; and
selectively send a command signal to the control device to switch the component from the second state to the first state based on the maintenance signal.

11. The control system of claim 10, further including an on-board controller connected with the component, the on-board controller comprising:
a microprocessor-based locomotive control system, wherein the microprocessor-based locomotive control system comprises a programmable logic controller (PLC) configurable to selectively set the predetermined range for the operating parameter; and
an integrated cab electronics system comprising at least one integrated display computer configured to:
receive and display data from the outputs of one or more of machine gauges, indicators, sensors, and controls;
process and integrate the received data;
receive the command signal from the off-board controller; and
supply commands based on the data and command signal to the microprocessor-based locomotive control system; and
the on-board controller being in wireless communication with the off-board controller.

12. The control system of claim 10, wherein a switch between the first state and the second state comprises one or more of a switch to an activated or enabled state, a switch to a deactivated or disabled state, a change in a quantity or flow rate of a fuel, a change in a quantity or flow rate of a coolant, a change in a quantity or flow rate of a reductant used in exhaust aftertreatment, a change in an electrical characteristic, a change in a temperature, a change in a pressure, a change in a rotational speed of the component, and a change in a physical location of the locomotive.

13. The control system of claim 11, further including:
a third party remote interface configured to:
receive a maintenance signal from the locomotive, the maintenance signal being indicative of the component having switched from the first state to the second state; and
selectively send a command signal to the control device to switch the component from the second state to the first state based on the maintenance signal.

14. The control system of claim 13, wherein the on-board controller further includes a third party signaling system configured to communicate with the third party remote interface and modulate command signals received from the third party remote interface for compatibility with the microprocessor-based locomotive control system.

15. The control system of claim 11, wherein the PLC is further configurable to receive one or more signals indicative of at least one of a throttle command, dynamic braking readiness, and a brake command, and output one or more corresponding command signals configured to change at least one of a throttle position for the locomotive, activation of dynamic braking, and application of a brake, respectively.

16. A method of controlling a machine, comprising:
switching a component located on-board the machine from a first state to a second state in response to an operating parameter of at least one subsystem of the machine deviating from a predetermined range;
transmitting a maintenance signal from the machine to a remote controller interface off-board the machine, the maintenance signal being indicative of the component having switched from the first state to the second state;
selectively receiving a command signal from the remote controller interface at a control device on-board the machine, the command signal causing the control device to autonomously switch the component from the second state to the first state.

17. The method of claim 16, further including:
configuring a programmable logic controller (PLC) of a microprocessor-based machine control system on-board the machine to selectively set the predetermined range for the operating parameter of the component;
receiving and processing data outputs from one or more of machine gauges, indicators, sensors, and controls of the machine at an integrated cab electronics system on-board the machine;
receiving and processing the command signal from the remote controller interface at the integrated cab electronics system on-board the machine;
supplying commands based on the processed data outputs and command signal from the cab electronics system to the PLC; and
switching the component from the second state to the first state with the microprocessor-based machine control system.

18. The method of claim 16, wherein a switch between the first and second states comprises one or more of a switch to an activated or enabled state, a switch to a deactivated or disabled state, a change in a quantity or flow rate of a fuel, a change in a quantity or flow rate of a coolant, a change in a quantity or flow rate of a reductant used in exhaust aftertreatment, a change in an electrical characteristic, a change in a temperature, a change in a pressure, a change in a rotational speed of the component, and a change in a physical location of the machine.

19. The method of claim 17, further including:
receiving a maintenance signal from the machine at a third party remote interface, the maintenance signal being indicative of the component having switched from the first state to the second state; and
selectively sending a command signal from the third party remote interface to a control device on-board the machine to switch the component from the second state to the first state.

20. The method of claim 19, further including:
sending the command signal from the third party remote interface to a third party signaling system on-board the machine;
modulating the command signal received from the third party remote interface for compatibility with the cab electronics system and the PLC;
receiving and processing the command signal from the third party remote interface at the integrated cab electronics system on-board the machine;
supplying a command based on the processed command signal from the cab electronics system to the PLC; and
switching the component from the second state to the first state with the microprocessor-based machine control system.
